(19) United States
(12) Patent Application Publication
(10) Pub. No.: US 2014/0026590 A1
(43) Pub. Date: Jan. 30, 2014

(54) FLEXIBLE COMBUSTOR BRACKET

(71) Applicant: Hannes A. Alholm, Tolland, CT (US)

(72) Inventor: Hannes A. Alholm, Tolland, CT (US)

(21) Appl. No.: 13/557,532

(22) Filed: Jul. 25, 2012

(51) Int. Cl. F02C 7/20; B23P 11/00

(52) U.S. Cl. 60/796; 29/428

(57) ABSTRACT

A bracket for an augmentor assembly of a gas turbine engine includes a first mount attachable to a support structure. A second mount is attachable to an augmentor pilot assembly and extends radially inward of the support structure. First and second spring members attach on a first end to the first mount and on a second end to the second mount. The first and second spring members include a center spring portion spaced apart from one another to allow sufficient relative radial and circumferential movement to accommodate differential thermal expansions throughout operation of the augmentor.

### STATEMENT REGARDING FEDERALLY SPONSORED RESEARCH OR DEVELOPMENT

This subject of this disclosure was made with government support under Contract No.: N00019-02-C-3003 awarded by the United States Navy. The government therefore may have certain rights in the disclosed subject matter.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. An augmentor is sometimes provided after the turbine to provide additional thrust capacity. Augmentors ignite additional fuel injected into the exhaust gas flow aft of the turbine. An augmentor includes brackets for suspending structures within the exhaust case and in the exhaust gas flow. Supporting such structures in the extreme environment of the exhaust system requires brackets that accommodate differences in thermal expansion along with high temperatures. Moreover, assembly in the confined space provided in the exhaust system can be difficult.

Therefore it is desirable to design and develop brackets for supporting augmentor structures that ease manufacturing and assembly while also withstanding exposure to the extreme environment.

### SUMMARY

An augmentor assembly for a gas turbine engine according to an exemplary embodiment of this disclosure, among other possible things includes an exhaust case, a pilot assembly disposed within the exhaust case, and a plurality of brackets supporting the pilot assembly within the exhaust case. Each of the plurality of brackets include first and second spring members extending between a first mount attached to the exhaust case and a second mount attached to the pilot assembly.

In a further embodiment of the foregoing augmentor assembly, the first and second spring members are identical.

In a further embodiment of any of the foregoing augmentor assemblies, the first and second spring members include a first end attached to the first mount and a second end attached to the second mount, and a center spring portion accommodating movement between the first mount and the second mount.

In a further embodiment of any of the foregoing augmentor assemblies, the center spring portion of the first and second spring members are spaced apart from each other.

In a further embodiment of any of the foregoing augmentor assemblies, the first mount comprises first and second fingers with a first end attached to the exhaust case spaced apart from each other and a second end attached to the first and second spring members.

In a further embodiment of any of the foregoing augmentor assemblies, the second mount comprises a first side attached to the first and second spring members and a second side attached to the pilot assembly.

In a further embodiment of any of the foregoing augmentor assemblies, the first side is transverse to the second side.

In a further embodiment of any of the foregoing augmentor assemblies, includes a first fastener assembly for attaching the first and second spring members to the first mount.

In a further embodiment of any of the foregoing augmentor assemblies, includes a second fastener assembly for attaching the second mount to the first and second spring members.

A bracket assembly for an augmentor pilot assembly of a gas turbine engine according to an exemplary embodiment of this disclosure, among other possible things includes a first mount attachable to a support structure, a second mount attachable to an augmentor pilot assembly radially inward of the support structure, and first and second spring members attached on a first end to the first mount and on a second end to the second mount. Each of the first and second spring members include a center spring portion spaced apart from one another.

In a further embodiment of the foregoing bracket assembly, the first and second spring members are identical.

In a further embodiment of any of the foregoing bracket assemblies, the first mount includes first and second fingers with a first end attached to the support structure spaced apart from each other and a second end attached to the first and second spring members.

In a further embodiment of any of the foregoing bracket assemblies, the second mount includes a first side including a first opening for a first fastener for attaching the first and second spring members to the second mount and a second side with a second opening for a second fastener for attaching the pilot assembly to the second mount, wherein the first and second openings are disposed transverse to each other.

A method of supporting an augmentor pilot assembly within an exhaust case according to an exemplary embodiment of this disclosure, among other possible things includes fixing a plurality of first mounts to a first assembly tool, aligning the plurality of first mounts fixed to the first assembly tool with mounting locations of an exhaust case, attaching the each of the first plurality of first mounts to a corresponding mounting location of the exhaust case, removing the first assembly tool from the plurality of first mounts, fixing a plurality of second mounts to a second assembly tool, first and second spring members are attached to each of the plurality of second mounts, aligning the each of the first and second spring members with a corresponding one of the first mounts, attaching the first mounts to the corresponding first and second spring members, removing the second assembly tool from the plurality of second mounts, and attaching an augmentor pilot assembly to the plurality of second mounts.

In a further embodiment of the foregoing method, includes attaching first and second spring members such that center spring portions of each of the first and second spring members are spaced apart from each other.

In a further embodiment of any of the foregoing methods, includes defining a circumferential spacing of the first mounts with the first assembly tool corresponding to a circumferential spacing of the mounting locations.

In a further embodiment of any of the foregoing methods, includes defining a circumferential and radial spacing of the second mounts with the second assembly tool that correspond to a desired position of the augmentor pilot assembly relative to the exhaust case.

In a further embodiment of any of the foregoing methods, includes attaching each of the plurality of first mounts to the corresponding first and second spring members with a first fastener assembly.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is an enlarged view of an augmentor assembly of the example gas turbine engine.

FIG. 3 is a front view of a portion of the example augmentor assembly.

FIG. 4 is a front view of an example bracket.

FIG. 5 is a side view of the example bracket.

FIG. 6 is an example view of a first step for mounting a portion of the augmentor assembly.

FIG. 7 is a schematic representation of a second step for mounting a portion of the augmentor assembly.

### DETAILED DESCRIPTION

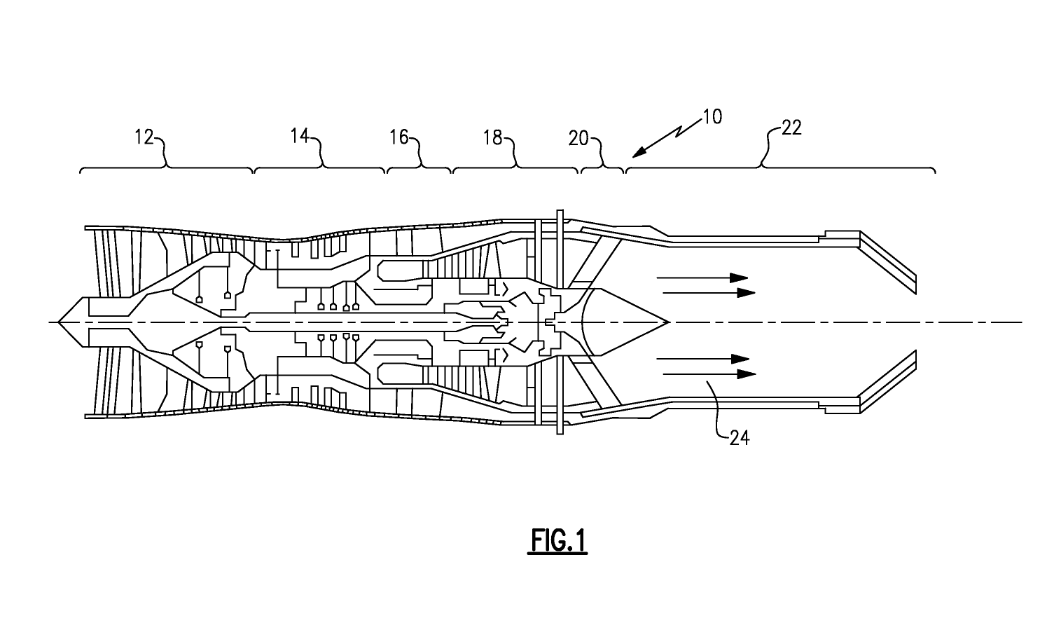

Referring to FIG. 1, a gas turbine engine 10 includes a fan section 12, a compressor section 14, a combustor section 16, and a turbine section 18 disposed about an axis A. Air entering the fan section 12 is initially compressed and fed to the compressor section 14. In the compressor section 14, the incoming air from the fan section 12 is further compressed and communicated to the combustor section 16. In the combustor section 16, the compressed air is mixed with gas and ignited to generate a hot exhaust gas stream 24. The hot exhaust stream 24 is expanded through the turbine section 18 to drive the fan section 12 and the compressor section 14.

In this example, the gas turbine engine 10 includes an augmentor assembly 20 where additional fuel can be mixed with the exhaust gas stream 24 and ignited to generate additional thrust. The exhaust gas stream 24 flow from the turbine section 18 and the augmentor assembly 20 exit through an exhaust system 22.

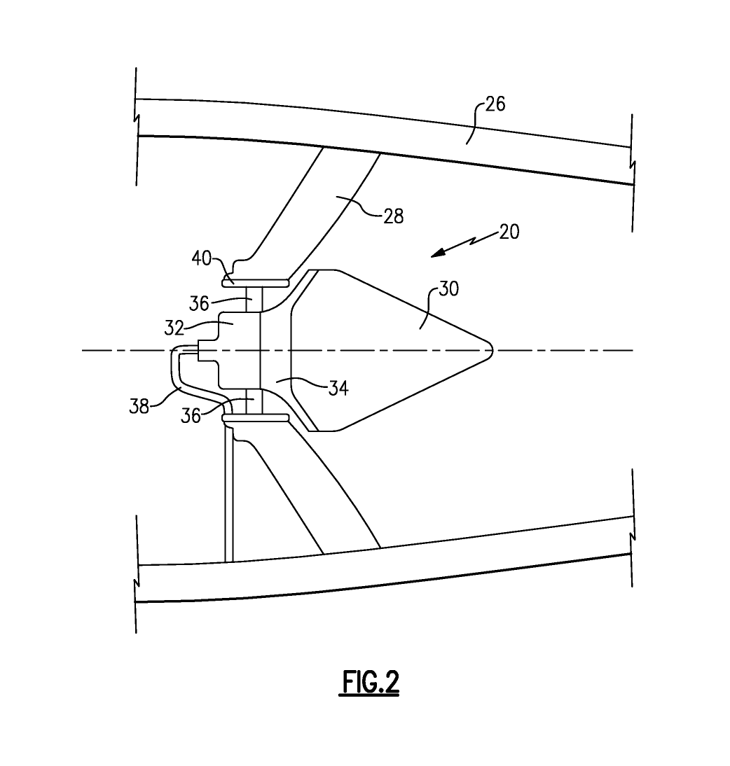

Referring to FIG. 2, the example augmentor assembly 20 is disposed within a turbine exhaust case 26. The turbine exhaust case 26 includes struts 28 that extend to a mounting ring 40. The mounting ring 40 supports the augmentor assembly 20 along the axis A. The example augmentor assembly 20 includes a tail cone 30 that is mounted to a flame holder 34. An augmentor pilot assembly 32 is further supported within the exhaust case 26. The augmentor pilot assembly 32 provides a pilot flame to initiate ignition of fuel supplied to the augmentor assembly 20. The example augmentor pilot assembly 32 is mounted to the mounting ring 40 by way of a plurality of brackets 36. In this example, the augmentor pilot assembly 32 is fed with fuel through fuel line 38. It should be understood that the example augmentor assembly 20 is disclosed by way of an example and may include additional features and structures. In the disclosed example, the mounting ring 40 and exhaust case 26 provide the support structure for the augmentor assembly 20.

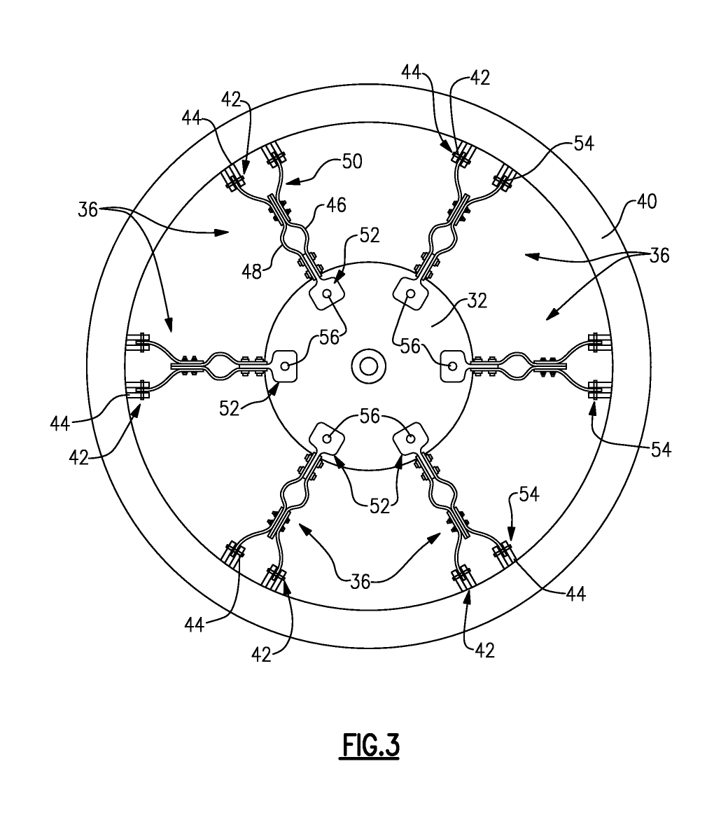

Referring to FIG. 3 with continued reference to FIG. 2, the example augmentor pilot assembly 32 is supported along the axis A within the turbine exhaust case 26 (FIG. 2) by the brackets 36. The brackets 36 are disposed at equally spaced locations about the mounting ring 40. As appreciated in this example, the mounting ring 40 is a component of the turbine exhaust case 26 and facilitates mounting and positioning of the augmentor assembly 20 within the turbine exhaust case 26. Moreover, in this example the brackets 36 are equally spaced, however, other spacing configurations are within the contemplation of this disclosure.

Each of the plurality of brackets 36 includes a first mount 50 that attaches to flanges 44 at corresponding mounting locations 42 disposed about the mounting ring 40. In this example, each mounting location 42 includes mounting flanges 44 to which the first mount portion 50 is attached by way of at least one fastening member 54. A second mount 52 is attached to the augmentor pilot assembly 32 by way of a second fastener 56. A first spring member 46 and a second spring member 48 extend between the first mount 50 and the second mount 52. The example mounting brackets 36 align the augmentor pilot assembly 32 within the turbine exhaust case 26. The brackets 36 radially locate the augmentor pilot assembly 32 and also are circumferentially spaced about the mounting ring 40.

Each of the brackets 36 includes the first and second spring members 46, 48 that provide for relative movement between the augmentor pilot assembly 32 and the mounting ring 40. As appreciated, the augmentor assembly 20 is disposed within a high temperature region and therefore must be capable of withstanding high temperatures. During times of activation, the temperatures within the augmentor assembly 20 will reach extreme levels and therefore the exhaust case 26, the augmentor assembly 20, including the augmentor pilot assembly 32 will thermally expand. As appreciated, the materials and temperature exposure of each of the component parts differ and therefore there can be large differential thermal expansions between relatively positioned components. The first and second spring portions 46, 48 of the brackets 36 accommodate relative movement between the augmentor pilot assembly 32 and the turbine exhaust case 26.

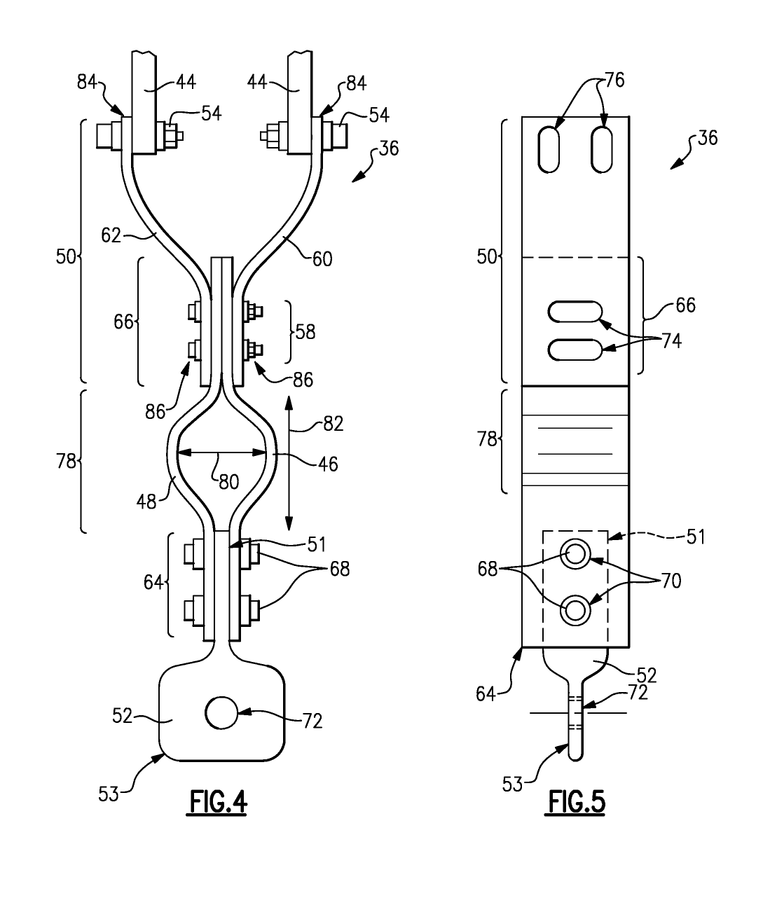

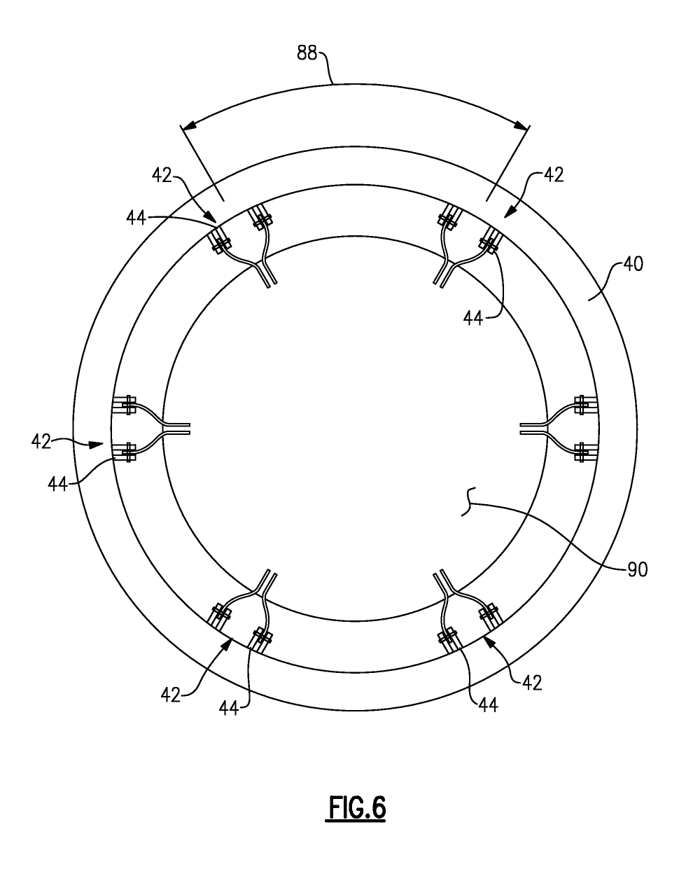

Referring to FIGS. 4 and 5 with continued reference to FIG. 3, each of the example brackets 36 includes the first and second spring members 46, 48 that are attached and extend between the first mount portion 50 and a second mount 52. The first mount portion 50 includes first and second fingers 62, 60. The first and second fingers 62, 60 include a second end 86 attached by way of a fastener assembly 58 to the spring members 46, 48. A first end 84 of the first and second fingers 62 and 60 attach to mounting flanges 44 mounted within the turbine exhaust case 26. The first ends 84 of the first and second fingers 60, 62 are spaced apart from each other. The second ends 86 of the first and second fingers 60, 62 are abutted against each other. Fastener assembly 54 extends through the flanges 44 to provide for attachment of the first mount portion 50.

The second mount 52 includes a first side 51 attached to the first and second spring members 46, 48 and a second side 53 attached to the pilot assembly 32. The second mount 52 includes an opening 72 in the second side 53 through which the fastener 56 (FIG. 3) extends to attach to the augmentor pilot assembly 32. The first side 51 of the second mount 52 includes openings 70 for fasteners 68 that attach the second mount 52 to the first and second spring members 46, 48. In this example, the fasteners 68 are rivets that attach the second mount 52 to the first and second spring members 46, 48. It should be understood that although rivets are disclosed, the fastener 68 may comprise any fastening member compatible with the environment within the augmentor assembly 20.

Each of the first and second spring members 46, 48 includes a second end 64 attached to the second mount 52, and a first end 66 that is attached to the first mount portion 50. A center spring portion 78 is disposed on each of the first and second spring members 46, 48 and defines a spacing 80 therebetween. The spacing 80 is a bend at a midway portion between the first end 66 and the second end 64. The center spring portion 78 accommodates expansion and contraction in a direction indicated by arrow 82 so that spacing between the first mount portion 50 and the second mount 52 can vary to accommodate relative thermal expansion between portions of the augmentor assembly 20. The example first and second spring members 46, 48 are identical parts assembled in a mirrored orientation to each other.

The fastening members 58 that attach the first mount 50 to the first and second spring members 46, 48 extend through slots 74 in the fingers 60, 62. The slots 74 allow for adjustment during assembly such that the bracket assembly 36 can accommodate manufacturing and build tolerances. The first mount 50 also includes slots 76 that receive the fasteners 54 that attach the first mount to the flanges 44 of the mounting ring 40. Slots 76 also provide radial adjustment of the bracket assembly 36 to support the augmentor pilot assembly 32 within the turbine exhaust case 26.

The second mount 52 includes the opening 72 for the fastener 56 that attaches to the augmentor pilot assembly 32. The opening 72 is disposed along an axis transverse to the opening 70 for the rivets 68 that attach to the first and second spring members 46, 48. Transverse orientation between the opening 70 and the opening 72 allows for the surface mounting of the mount 52. As appreciated, space for assembly of the augmentor pilot assembly 32 is limited and, therefore, the fasteners 56 are oriented in a manner such that they may be assembled from an aft opening of the exhaust system 22 (FIG. 1).

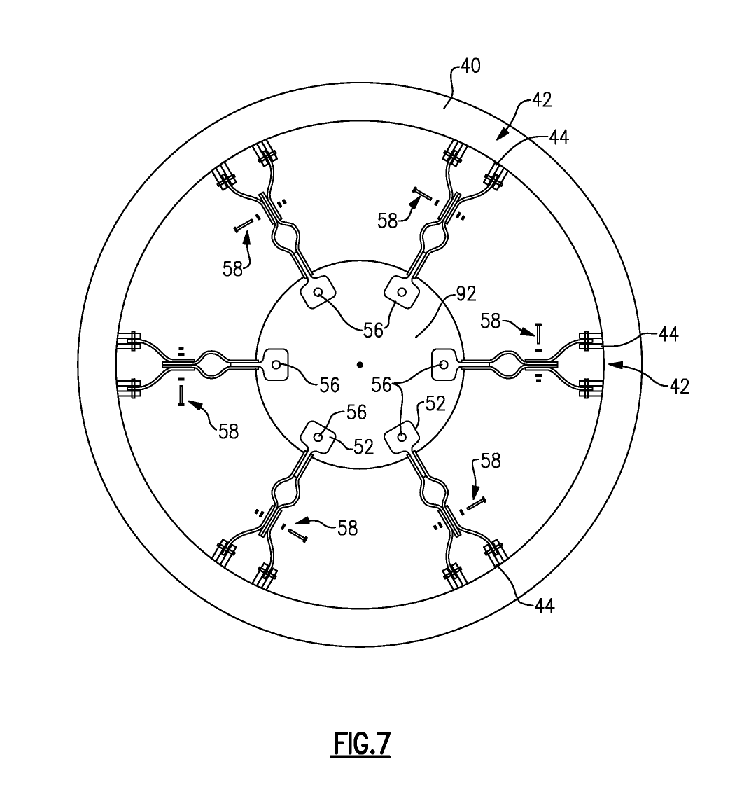

Referring to FIG. 6, a method of assembling the augmentor pilot assembly 32 within the turbine exhaust case 26 includes a first step of attaching the plurality of first mount sections 50 to a first assembly tool 90. The first assembly tool 90 includes flanges 94 to which the first mount 50 can be attached. The assembly tool 90, including the plurality of first mounts 50 is then aligned within the exhaust case 26 such that an end 84 of the plurality of mounts 50 aligns with the flanges 44 at the various mounting locations 42 on the turbine exhaust case 26. In this example, the portion of the turbine exhaust case to which the flanges 44 extend is described as a mounting ring 40. As appreciated, the mounting ring 40 represents that surface of the turbine exhaust case 26 that extends radially inward to provide for the support of the augmentor pilot assembly 32. The mounting ring 40 could also comprise a plurality of spokes that extend radially inward to which the brackets 36 may be assembled, or any other mounting structure to support the augmentor pilot assembly 32.

Once the first assembly tool 90 has aligned the first mounts 50 in their respective mounting locations 42, a fastener assembly 54 is attached to secure the first mount portions 50 at the mounting locations 42. The first assembly tool 90 provides for the circumferential spacing 88 between the mounting locations 42. That is, the assembly tool 90 defines mounting locations for each of the first mounts 50 that correspond with the circumferential spacing 88 of the mounting locations 42 such that when properly aligned, each of the plurality of first mounts 50 align with the corresponding flange 44. In this example, six mounting brackets 36 are utilized. However, other numbers of mounting brackets could also be utilized to provide for mounting of the example augmentor pilot assembly 32. Once each of the first mounts 50 are at the corresponding mounting location 42, the first assembly tool 90 is removed.

Referring to FIG. 7, a second assembly tool 92 is then utilized to align and mount the remaining portions of the bracket assembly 36. In this example, the second mounting tool 92 includes mount locations for attaching of the second mount 52 at circumferentially spaced locations that correspond to the current positions of the corresponding first mount portion 50. Attached to the second mount 52 are the first and second spring members 46, 48. The first and second spring members 46, 48 are attached to the second mount 52 that is in turn attached to the assembly tool 92. The assembly tool 92 aligns each of the bracket assemblies radially and circumferentially with the first mount 50.

Once the first mounts 50 are aligned to the corresponding first and second spring members 46, 48, the fastening assembly 58 including a bolt, washer and nut are extended through the first mount 50 and the corresponding first and second spring members 46, 48. The fastening assemblies 58 are then tightened and the second assembly tool 92 may be removed. In the disclosed examples a bolt, washer and nut are shown, however, other fastener assemblies may also be utilized. Once the second assembly tool 92 is removed, the brackets 36 are disposed circumferentially and radially about the inner surface of the turbine exhaust case 26 in an orientation for receiving and supporting the augmentor pilot assembly 32. The augmentor pilot assembly 32 may then be attached to the second mounts 52.

The example brackets 36 are fabricated from sheet material comprised of a material composition capable of withstanding the conditions within the exhaust section of the gas turbine engine 10. Moreover, the central spring section 78 of the first and second spring members 46, 48 is configured to allow sufficient relative radial and circumferential movement between the augmentor pilot assembly 32 and the turbine exhaust case 40 to accommodate differential thermal expansions throughout operation of the augmentor assembly 20.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An augmentor assembly for a gas turbine engine comprising:
an exhaust case;
a pilot assembly disposed within the exhaust case; and
a plurality of brackets supporting the pilot assembly within the exhaust case, each of the plurality of brackets including first and second spring members extending between a first mount attached to the exhaust case and a second mount attached to the pilot assembly.

2. The augmentor assembly as recited in claim 1, wherein the first and second spring members are identical.

3. The augmentor assembly as recited in claim 1, wherein the first and second spring members include a first end attached to the first mount and a second end attached to the second mount, and a center spring portion accommodating movement between the first mount and the second mount.

4. The augmentor assembly as recited in claim 3, wherein the center spring portion of the first and second spring members are spaced apart from each other.

5. The augmentor assembly as recited in claim 1, wherein the first mount comprises first and second fingers with a first end attached to the exhaust case spaced apart from each other and a second end attached to the first and second spring members.

6. The augmentor assembly as recited in claim 1, wherein the second mount comprises a first side attached to the first and second spring members and a second side attached to the pilot assembly.

7. The augmentor assembly as recited in claim 6, wherein the first side is transverse to the second side.

8. The augmentor assembly as recited in claim 1, including a first fastener assembly for attaching the first and second spring members to the first mount.

9. The augmentor assembly as recited in claim 1, including a second fastener assembly for attaching the second mount to the first and second spring members.

10. A bracket assembly for an augmentor pilot assembly of a gas turbine engine, the bracket assembly comprising:
a first mount attachable to a support structure;
a second mount attachable to an augmentor pilot assembly radially inward of the support structure; and
first and second spring members attached on a first end to the first mount and on a second end to the second mount, wherein each of the first and second spring members includes a center spring portion spaced apart from one another.

11. The bracket assembly as recited in claim 10, wherein the first and second spring members are identical.

12. The bracket assembly as recited in claim 10, wherein the first mount comprises first and second fingers with a first end attached to the support structure spaced apart from each other and a second end attached to the first and second spring members.

13. The bracket assembly as recited in claim 10, wherein the second mount comprises a first side including a first opening for a first fastener for attaching the first and second spring members to the second mount and a second side with a second opening for a second fastener for attaching the pilot assembly to the second mount, wherein the first and second openings are disposed transverse to each other.

14. A method of supporting an augmentor pilot assembly within an exhaust case;
fixing a plurality of first mounts to a first assembly tool;
aligning the plurality of first mounts fixed to the first assembly tool with mounting locations of an exhaust case;
attaching the each of the first plurality of first mounts to a corresponding mounting location of the exhaust case;
removing the first assembly tool from the plurality of first mounts;
fixing a plurality of second mounts to a second assembly tool, wherein first and second spring members are attached to each of the plurality of second mounts;
aligning the each of the first and second spring members with a corresponding one of the first mounts;
attaching the first mounts to the corresponding first and second spring members;
removing the second assembly tool from the plurality of second mounts; and
attaching an augmentor pilot assembly to the plurality of second mounts.

15. The method as recited in claim 14, including attaching first and second spring members such that center spring portions of each of the first and second spring members are spaced apart from each other.

16. The method as recited in claim 14, including defining a circumferential spacing of the first mounts with the first assembly tool corresponding to a circumferential spacing of the mounting locations.

17. The method as recited in claim 14, including defining a circumferential and radial spacing of the second mounts with the second assembly tool that correspond to a desired position of the augmentor pilot assembly relative to the exhaust case.

18. The method as recited in claim 14 including attaching each of the plurality of first mounts to the corresponding first and second spring members with a first fastener assembly.
